(19) United States
(12) Patent Application Publication
(10) Pub. No.: US 2021/0200427 A1
(43) Pub. Date: Jul. 1, 2021

(54) Worldwide Drawn Guide Directory

(71) Applicant: Ashley SinHee Kim, Centreville, VA (US)

(72) Inventor: Ashley SinHee Kim, Centreville, VA (US)

(21) Appl. No.: 17/126,001

(22) Filed: Dec. 17, 2020

Related U.S. Application Data
(60) Provisional application No. 62/949,427, filed on Dec. 17, 2019.

(51) Int. Cl. G06F 3/0484; G06Q 30/02; G06F 3/0481; G06F 40/134; G06K 9/00; G02B 30/56

(52) U.S. Cl. CPC G06F 3/04842; G06Q 30/0281; G02B 30/56; G06F 40/134; G06K 9/00624; G06F 3/04817

(57) ABSTRACT

A computer-implemented method for a directory guide, that is configured by showing the image as special visual icons that serve the function of compressing all relevant information of the implied business at once. This method focuses on convenient access by applying a visualization system that is easy for people to recognize. It also uses a method that increases the effectiveness of visual display by showing the corresponding object of an icon in a 2-D plane so that it can appear visually 3-D.

### BACKGROUND OF MY INVENTION

After the Fourth Industrial Revolution (IR), it became possible to obtain information in various forms and recall the desired data through corresponding service engines. The Fourth Industrial Revolution is a next-generation industrial revolution created by the fusion of ICT. It is the fourth most important industrial age since the early eighteenth century industrial revolution. The core of this revolution is new technological innovation in seven areas: big data analytics, artificial intelligence, robotics, the Internet of Things, unmanned transportation (manned aircraft, unmanned vehicles), 3D printing, and nanotechnology.

The Fourth Industrial Revolution can be described as a variety of new technologies that integrate the physical, biological and digital world based on big data and affect all areas, including economy and industry. The integration of the physical and digital worlds is accomplished through O2O, and in the biological world, mobile healthcare can be implemented using smartwatches or smart bands, a technology that incorporates human information into the digital world.

In this respect, my invention integrates the old methods with current ideas and approaches them visually in a different way than previously done, and still in accordance with the Fourth Industrial Revolution. This is done by creating a directory through pictures and holograms to help users understand involved businesses and recognize them quickly.

### SUMMARY OF INVENTION

As people, we are constantly searching for new information and putting in energy to find the most relevant. Previously, all existing information that went into directories took on the form of paper newsletters or brochures. But the invention of the computer created the new application form (computer, mobile) which became more widely used, giving us more benefits and positive impact. The people of today's era who live in the Fourth Industrial Revolution are oriented toward the intelligent world of the custom age through connectivity, decentralization/dispersion, and sharing/openness. Various technologies such as big data, artificial intelligence, and blockchain are used to build this intelligent world. For the intelligence of the custom age, all the contents of the real world can be connected to the virtual world, and then, through big data/artificial intelligence analysis in the virtual world, predicting predictions and alignment and applying them to the real world. Such mechanisms aim to create technology in a more accessible directory guide format. Using more familiar pictures and holograms rather than guides made of complex text, through this invention anyone can easily obtain information by using a pencil drawing, scanning, uploading, downloading, and coding so that users can easily increase interest and recognize regardless of age.

For people with visual constraints, this application will provide voice-activation features and audio-reading. One or more of the strengths/iconic features of the business are shown in holograms, allowing people's desire to collect information and understand complex information efficiently. This invention is useful as a way to focus on parsing and identifying the strengths of a business and increases the marketing and promotion for the owner of the business.

The overwhelming amount of information that is poured into standard writing is too general to properly promote businesses, so this invention uses a visual information collection approach. This mechanism can quickly be recognized by users by highlighting the characteristics of a business and displaying its matching logo with a single symbol in a directory. This is an idea that focuses on business advantages and helps it become more well known for its top-recommended features.

### DESCRIPTION OF DRAWING

This is a drawn directory realized through technology: application, website, etc.

FIG. 1 a directory created through an application

FIG. 2 a restaurant/business is depicted.

FIG. 3 each location is divided into city, town, and state,

FIG. 4. cursor to press the icon.

FIG. 5 each business has its own symbol.

FIG. 6 clicking the icon with the cursor, the code calls the information of the corresponding company.

FIG. 7 page shows hologram—as shown in Drawing 2.

FIG. 8 in Drawing 2 the top recommended item (i.e. cake) of the business appears as a hologram.

FIG. 9 voice button presents voice-assist option.

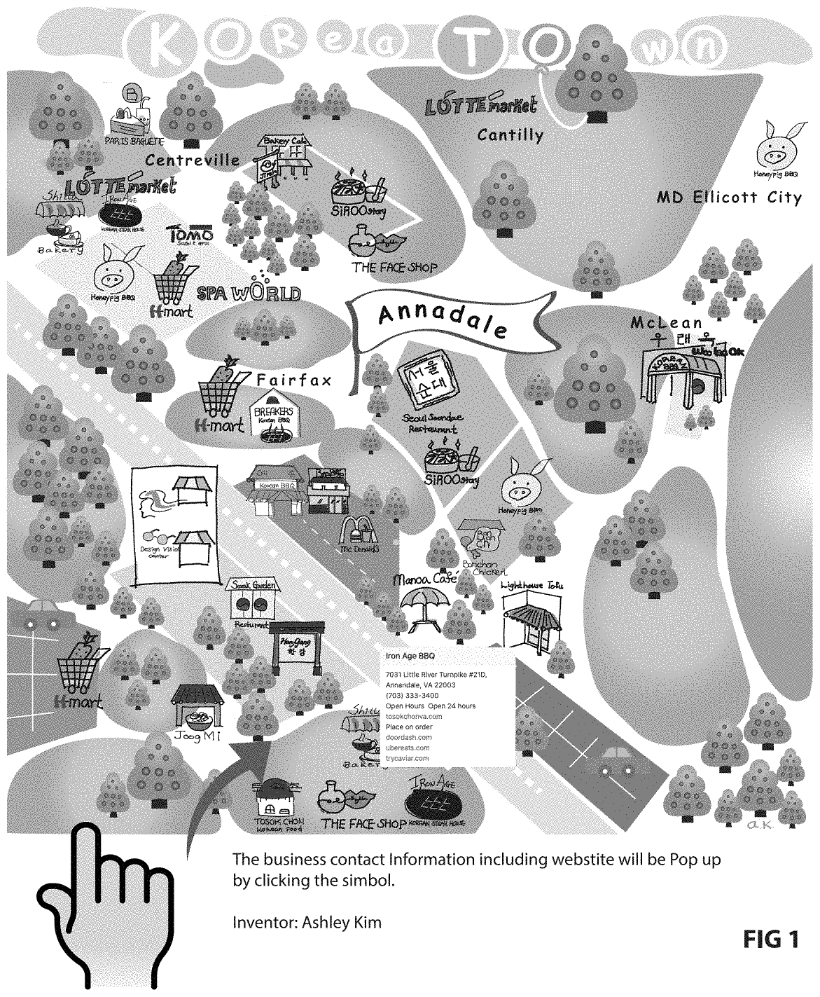

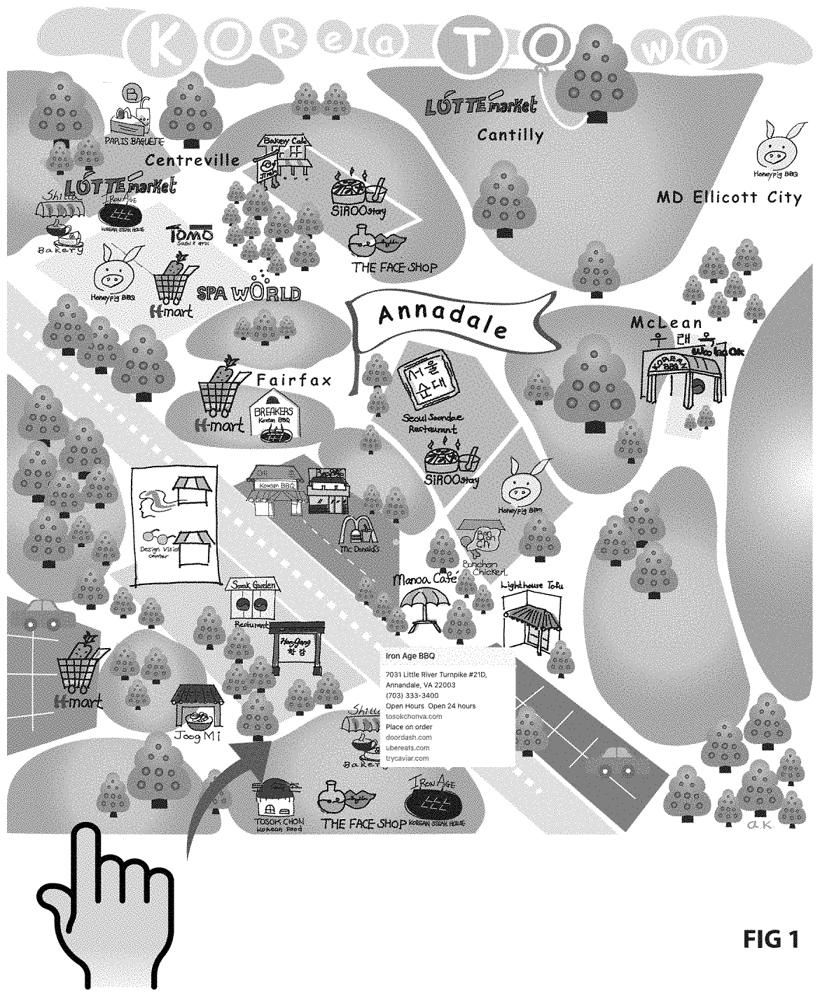

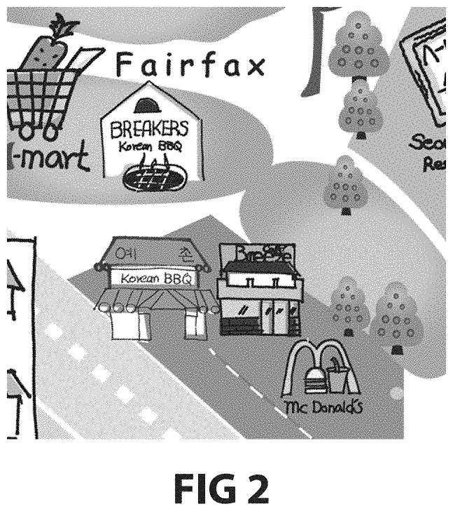

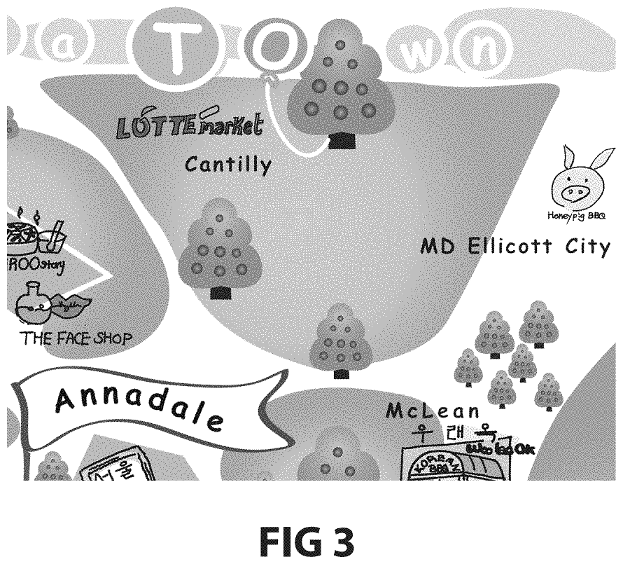

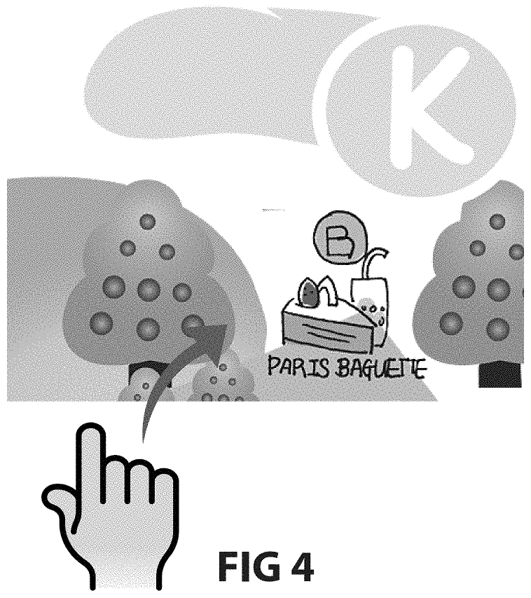

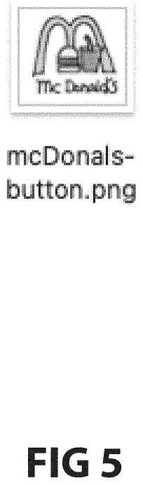

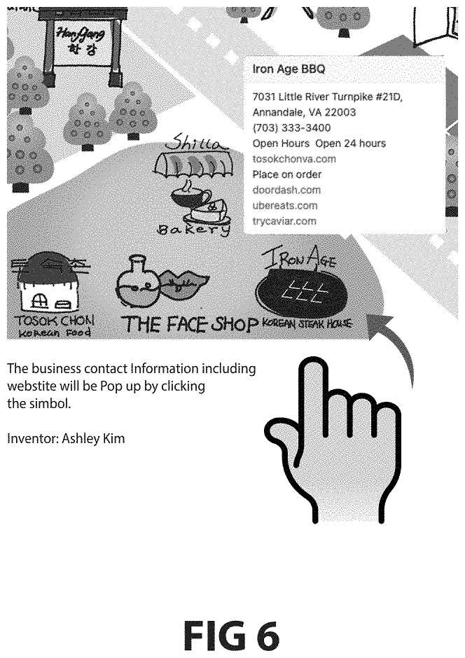

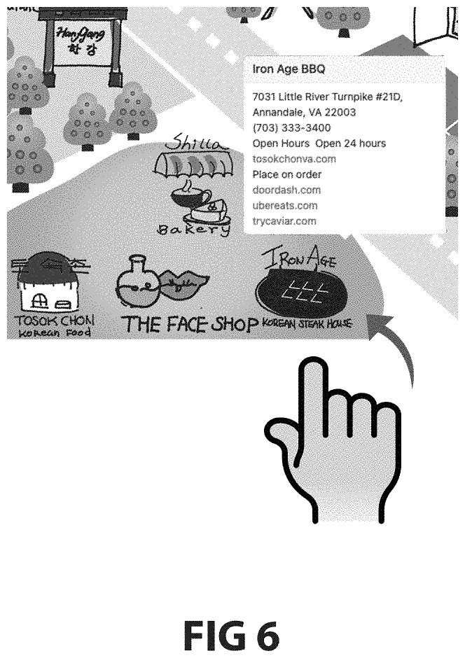

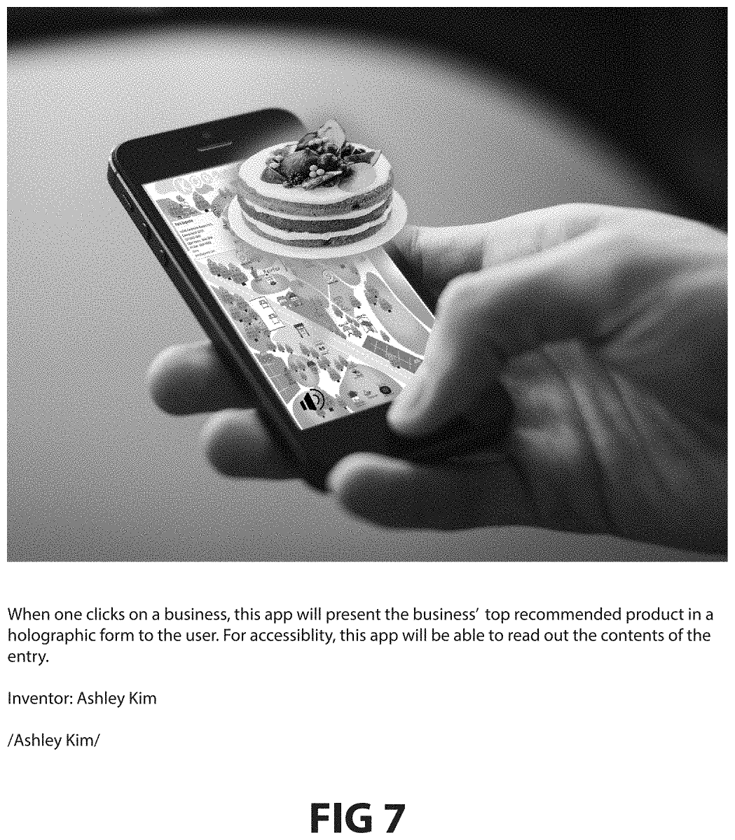

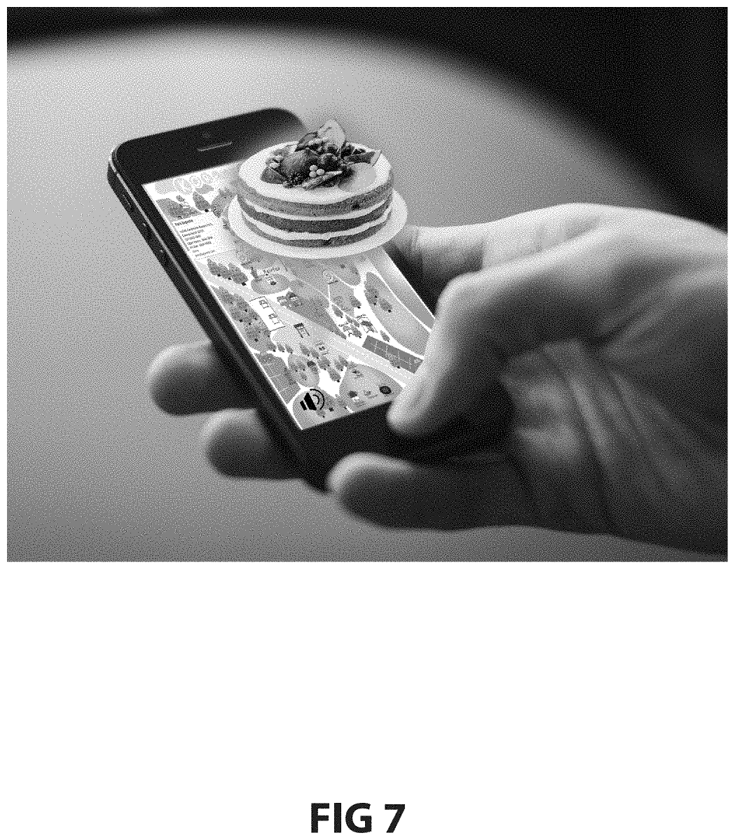

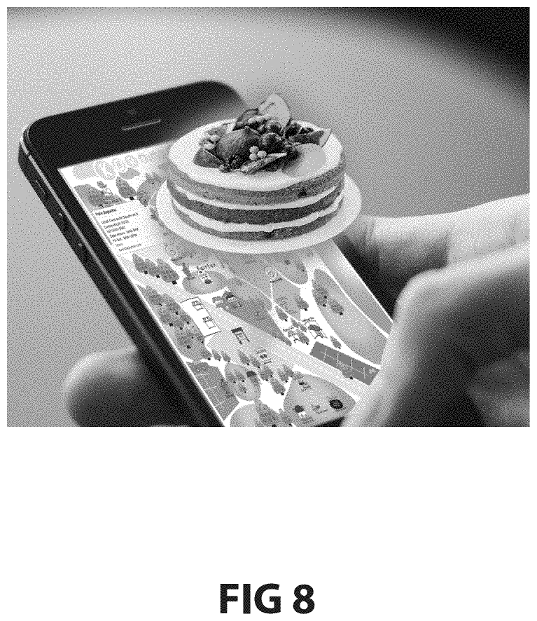

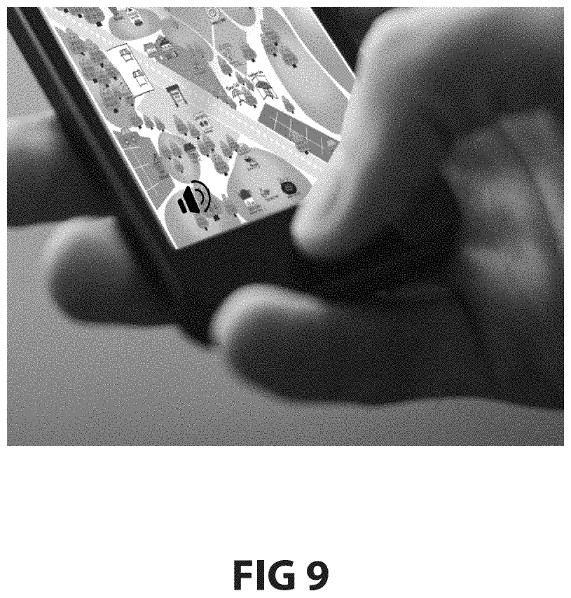

### DETAILED DESCRIPTION

To better understand the present invention, which is turned into a visual format of an unprecedented directory, and at the same time, everything can be seen at a glance to organize different types of directories into apps. What sets this particular directory apart, is the use of individually illustrated icons that represent businesses not just as a data point on a map, but with easily viewable icons that efficiently represent businesses so that they are easily recognizable by the user. The purpose is to symbolize the proper characteristics of the business with the use of colors or logos that identify the signature of the company characteristic/symbol, which transfer to functional icons/designs so that users can easily access them. So, this visual icon is realized through a coding mechanism that calls for information when users click on the designated symbols. The primary advantage of this directory is that it capitalizes on selecting the advantages of the company that they have not realized themselves.

The invention allows users to experience both 2D and 3D viewings of the directory all at once. The 2D version is characterized by hand-painted illustrative techniques that represent the analog/old ways to make it easy to understand regardless of age with a clear, clean, and comfortable user experience. This hand-drawn design is scanned back into the computer and re-illustrated into digital design. Numerous icons for each participating business will be generated and each will be placed on the directory map. Each icon will have the characteristic of being able to call out all information that is currently unavailable to the public when clicked on, and take on the characteristics of the designated business, invoking more information that is currently available to the public by clicking on each medium. The 2D drawing icon, which once was a simple design, looks friendly and simple to look at, but actually has a wide range of properties within it, providing users with a service to call out the data. Using coding, a new technology provided by the quadratic industry after 2010, each icon can be freely moved to the desired position via x and y indicators by the longitudinal and latitudinal coordinates. That means if a business were to move to another location, the directory can be re-coded to the new coordinates. The directory is designed to be flexible and displayed elsewhere.

The Merit of this invention is a computer-type app directory that lets people know the advantages of businesses and displays them quickly and easily. Of course, the location of businesses on existing map applications can be known through photos or satellites, and many information can be found, but they do not have any unique qualities. This directory has a unique approach by creating recognizable icons by hand, and takes advantage of the exterior characteristics of the businesses.

The 2D icons are also transformed into 3D holograms that use the prism of the three primary colors (RGB) that computers currently use for displays in other different ways. This invention is composed of my own holograms that do not exist before through a coding program that becomes a canvas launched by a projector and sends hidden media out above the screen.

The product shown in this hologram is the top recommended product that the business would most like promoted and will be the specific product or food that the company has. Such products like “chefs top recommended” or “hot items” in businesses if visualized as holograms, will promote users' interest in finding the best information on the market and help business owners develop more.

1. A method of a 2-D symbol, comprising: icons on each medium representing a logo and a picture, which allows the user to click on to receive information. Also, by clicking on it, customers can view their signatures items through a hologram.

2. The method of claim 1, wherein the logo is inside the symbol.

3. The method of claim 1, wherein the logo and the exterior design of the building are drawn together.

4. The method of claim 1, wherein one icon is completed by a coloring system that establishes the signature of the company.

5. The method of claim 2 has its own location.

6. The method of claim 2 is divided into city and town.

7. The method of claim 1, wherein one or more icons are placed in their corresponding areas.

8. The method of claim 3, wherein all icons are coded by latitude and longitude coordinates, which then places them in the designated area.

9. The method of claim 4, wherein a code commands a pop-up window to appear.

10. The method of claim 4, wherein code comments the pop-up to show the information that businesses currently have listed.

11. The method of clamp 4, wherein there is a hyperlink, so you can find various information in the pop-up window.

12. The method of claim 5 responds to a projector-type coding that shoots the prism of RGB out when clicked.

13. The method of claim 5 there is a system that accepts and operates by clicking on the icon.

14. The method of claim 6, wherein the RGB color of the computer is responsible for projecting the hologram from the display's surface (mobile phone).

15. The method of claim 6, wherein the code commands the projector to read and recognize the icon selected by the user and displays the icon through a projected hologram.

16. The method of claim 7, wherein the projector is commanded by the code to visualize the shape of the icon in 3D by launching a prism outside the screen.
